(19) United States
(12) Patent Application Publication
(10) Pub. No.: US 2009/0174867 A1
(43) Pub. Date: Jul. 9, 2009

(54) SYSTEM AND METHOD FOR REDUCING IMAGE ARTIFACTS IN A PROJECTION DEVICE USING A SCROLLING REFRACTIVE ELEMENT

(75) Inventor: Koen Malfait, Roeselare (BE)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: BARCO NV, Kortrijk (BE)

(21) Appl. No.: 11/971,102

(22) Filed: Jan. 8, 2008

(51) Int. Cl. G03B 21/14; G02B 26/08

(52) U.S. Cl. 353/69; 359/226.2

(57) ABSTRACT

A system and method for reducing speckle and smearing phenomena caused by a coherent light source. The light beam from the coherent light source is preferably refracted by a rotating refractive element. The refracted beam is focused and projected through a light valve by a plurality of optical components. The rotation of the refractive element causes the beam to scroll across the surface of a light receiving element, which reduces the smearing effect. The rotation of the refractive element also causes the propagation path of the beam to vary, causing rays of the light beam to undergo relative phase shift, varying the interference pattern on the light receiving element, resulting in a reduction in the appearance of the speckle phenomenon.

### BACKGROUND OF THE INVENTION

1. Technical Field

The present system relates to a system and method for reducing speckle artifacts from a monochromatic coherent light source in a light projection device.

2. Description of Related Art

A new generation of projection devices is emerging, in which conventional arc lamps are replaced by other technologies, such as light emitting diodes (LEDs) and lasers. LED and laser light sources have significant advantages over conventional arc lamps.

The efficiency of LEDs has improved substantially during the last decade increasing the lifespan of LED devices, making LEDs an economically valuable alternative to conventional lamps. In addition, the spectral characteristics of LEDs produce more saturated colors than a white arc lamp, which requires dividing the light spectrum to produce the three primary colors. The ability to modulate LEDs is also advantageous because it allows color sequential illumination in projection devices while employing a single light modulator. Further, the ability to dim LEDs enables generating high dynamic contrast ratios in a projection device.

Laser light sources provide the benefits of LEDs described above, as well as additional advantages. Laser light sources produce dramatically greater color saturation because the monochromatic nature of laser light creates perfect saturation of the primary colors.

Further, the étendue value of a laser light source is significantly smaller than present in lamps or LEDs, in many instances approaching zero. The étendue value characterizes how “spread out” light from a source is in area and angle. The étendue of a laser light source is exceptionally small because of the laser's very small emitting surface, and very small opening angle.

Optical components may also effect the étendue of a light beam. The properties and physics of light, however, dictate that the étendue of a light beam can never be reduced without the beam losing intensity. The étendue of a light beam may effect its ability to interact with the components of an optical system in a desired manner. For example, a light modulator may consists of 1920×1080 small mirrors which can flip around their diagonal to achieve three positions: +12; −12; and 0 degrees. Therefore, an incident light beam can only be separated from a reflected light beam by the modulator if the opening angle is less than 24 degrees. Consequently, this limits the étendue of a light source which can be completely used by this modulator. Laser light sources have an exceptionally small étendue and emitting surface, enabling a light beam from a plurality of lasers to be accommodated by the surface of a single modulator.

An additional advantage of certain lasers is their ability to be intermittently switched on and off, enabling enhanced modulation of the light source. Further, the fixed polarization state of certain laser light beams allows lasers to be used with projection devices employing light valves that require polarized incident light. Such light valves may comprise liquid crystal display or liquid crystal on silicon elements.

A complication with laser light sources arises from the coherent nature of the light beams. The light rays in a laser beam propagate in phase, which makes them likely to interfere with each other. The coherence of laser beams creates a speckle artifact upon interacting with a surface. This speckle pattern is caused by the dual nature of light. Light travels in waves and interacts with matter as a particle. When multiple light rays arrive at the same point on a surface in phase, the waves constructively interfere producing increased intensity. When the waves arrive out of phase by half a wavelength destructive interference occurs causing the light rays to cancel each other out. Multiple interference effects may be present on a surface. At positions on the surface where constructive interference occurs, a bright spot is witnessed. At positions where destructive interference occurs, no light is observed. The resulting is a speckled pattern is referred to as the speckle phenomenon.

A conventional technique to reduce the speckle phenomenon is to destroy the coherence of the light by using an electrophoretic diffuser, as described in U.S. Patent Application No. 2007/0058135 and European Patent Application No. 1,510,851. The electrophoretic diffuser comprises electrophoretic elements in an aqueous solution, which are vibrated by applying an alternating current to electrodes disposed at opposite ends of the diffuser. The aqueous solution of electrophoretic elements scatters the light rays, altering the direction of propagation of the rays. Movement of the electrophoretic elements ensures that the change in direction of propagation will vary temporally, resulting in a temporally homogenized interference pattern. Consequently, the interference pattern will be less observable since it is no longer a static phenomenon.

A major disadvantage to this technique is that the electrophoretic diffuser substantially increases the étendue of a light beam and alters the polarization state of the light rays. Consequently, the diffuser is impractical or completely in compatible with certain optical systems.

Another artifact phenomenon prevalent in projection devices employing LCDs is “smearing.” Smearing is caused by the combination of the inherent delay in the response time of pixels and the “sample and hold effect.” FIG. 1a illustrates a graph of the delay in response time of pixels of a light valve. The time it takes a pixel to transition from full black to full white, or vice-a-versa, can be broken down into time component t₁ and t₂. The first time component t₁ represents the delay between the application of a voltage to the LCD electrodes and the crystals beginning to rotate. The second time component t2 represents the time necessary for the crystals to fully rotate. If one considers an image comprising a white moving object which is refreshed at a refresh rate of v for which 1/v is approximately equal to t1 plus t2, it is clear that that the moving object will have a comet-like tail where the crystals are still responding to the demand to display black.

FIG. 1b illustrates a graph depicting the “sample and hold effect.” The movement of an object is illustrated by line 10. The solid flat lines 15a-d depict the position at which the object is displayed for time t_{d}, which is equal to the frame rate. The human eye follows the movement of the object along line 10. The position of a displayed object, however, is generally not aligned with its movement. Consequently, on the retina of the eye the attention point and the displayed image do not coincide, causing blur.

One approach to reduce this problem is described in European Patent No. 1,575,306 to Akiyama (“Akiyama”). Akiyama discloses blocking the light during a certain percentage of the frame (e.g. ½^{nd}) so that the delay time and a part of the rise time is dark (no light reaches the device). The transition of curve is no longer visible. An extra benefit is that the sample and hold effect is also reduced, as the temporal position is only illuminated half of the time, which introduces a small shift of the eye movement curve and only half of the error remains.

In Akiyama, a polygonal prism with a square base surface is rotated such that a parallel light bundle is displaced with respect to its initial axis by refraction due to the glass component. The displacement of the light bundle varies with the rotation of the prism. The light bundle can scroll across a light valve from bottom to top, where it jumps towards the bottom again as the initial light ray sees the edge of the prism. The polygon can also be a hexagon or an octagon or any arbitrary symmetric polygon.

Similar approaches are described in U.S. Pat. Nos. 5,416,514 and 5,410,370 and U.S. Patent Application No. 2003/123030. In these patents, a light band composed out of 3 color subbands is scrolled across a light valve, illuminating only a part of the light valve at a time. For scrolling color illumination, ideally ⅓^{rd} of the light valve is illuminated by a red band, ⅓^{rd} by a green band and ⅓^{rd} by a blue band, which scroll along the light valve and pop up at the bottom when the leave at the top (or vice versa). If the signal processing is synchronized, the correct image is displayed. This has the advantage that all light can be used, contrary to a color sequential system such as the standard single-chip DLP operation mode (with a color wheel, which, in time, transmits red, green and blue light). In the case of a white scrolling bar across the light valve, the LCD panel can be refreshed in a synchronized way as the light spot is moving in such a way that the response behavior occurs during the period the spot is not present. Additionally, the ‘sample and hold’ effect is reduced by a factor 2.

Another method of achieving the same effect is demonstrated by U.S. Patent Application No. 2003/007134, where the scrolling illumination is introduced by a rotating component, which allows at every time t only partial illumination of the light valve. This method introduces light losses where this are not necessarily the case for the Akiyama-approach.

None of the principles behind these approaches have been integrated into a projection system employing monochromatic lasers to reduce speckle phenomenon. Therefore, a need remains for a system and method for reducing speckle and smearing phenomena produced by a laser light source without increasing the étendue of a light beam or effecting the polarization state of the light rays

### BRIEF SUMMARY OF THE INVENTION

Embodiments of the present invention are directed to a system and method for reducing speckle and smearing phenomena caused by a coherent light source. The light beam from the coherent light source is preferably refracted by a rotating refractive element. The refracted beam is focused and projected onto a light valve by a plurality of optical components. The rotation of the refractive element causes the beam to scroll across the surface of the light valve, which reduces the smearing effect. The rotation of the refractive element also causes the propagation path of the beam to vary, producing different interference patterns on a light receiving element, resulting in a reduction in the appearance of the speckle phenomenon.

In a particular exemplary embodiment, the optical system for reducing image artifacts in a light projection system comprises: a light valve having a plurality of rows of pixels; a monochromatic coherent light source emanating a light beam illuminating the pixels of the light valve; a plurality of optical components directing the light beam onto the light valve; and a rotating refractive element refracting the light beam emanating from the monochromatic coherent light source, the refractive element having a geometric configuration and refractive properties such that the propagation axis of a light ray exiting the refractive element is approximately parallel to the propagation axis of the ray entering the refractive element, the rotation of the refractive element altering the propagation path of the light beam through the optical system causing two or more rays refracted by the refractive element to undergo relative phase shift.

These and other features as well as advantages, which characterize various exemplary embodiments of the present invention, will be apparent from a reading of the following detailed description and a review of the associated drawings.

### BRIEF DESCRIPTION OF THE DRAWINGS

FIG. 1a illustrates a graph of the delay in response time of pixels of a light valve.

FIG. 1b illustrates a graph depicting the “sample and hold effect.”

FIG. 2 illustrates an optical system of a projection device according to an exemplary embodiment of the present invention.

FIG. 3a illustrates an integrating rod for homogenizing a light beam according to an exemplary embodiment of the present invention.

FIG. 3b illustrates an integrating rod according to an embodiment of the present invention.

FIG. 4 illustrates various phases of the rotation of a refractive element according to an exemplary embodiment of the present invention.

FIG. 5 illustrates a portion of the optical system according to an exemplary embodiment of the present invention.

FIG. 6a illustrates the principle of phase shift in a coherent light beam as the beam propagates through a refractive element.

FIG. 6b illustrates measurements from a phase detector located between a light source and a refractive element.

FIG. 6c illustrates measurements from a phase detector located between a refractive element and a light receiving element.

### DETAILED DESCRIPTION OF PREFERRED EMBODIMENTS

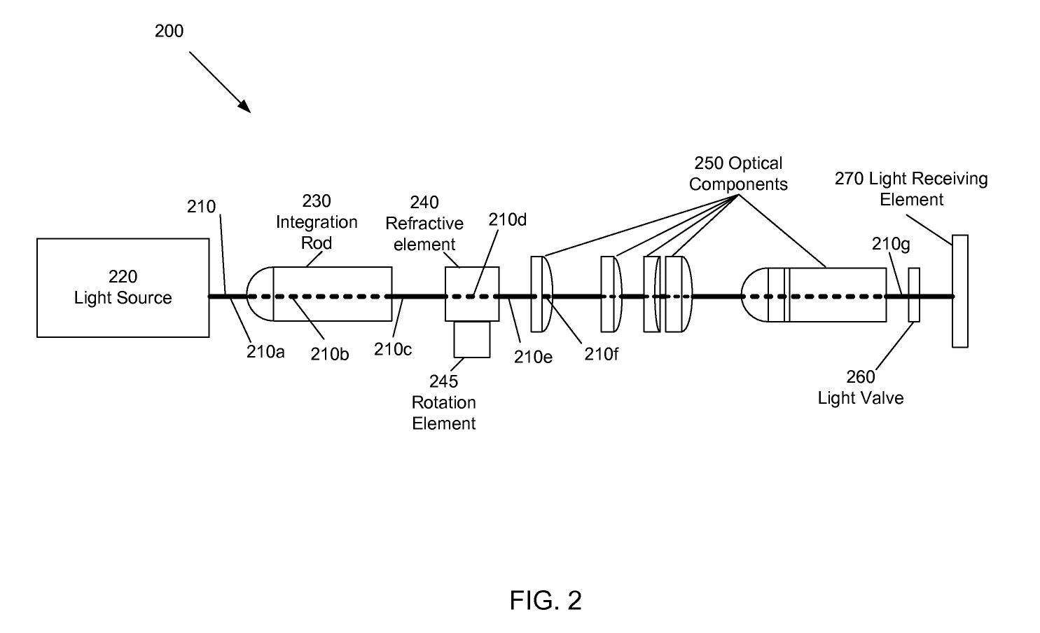

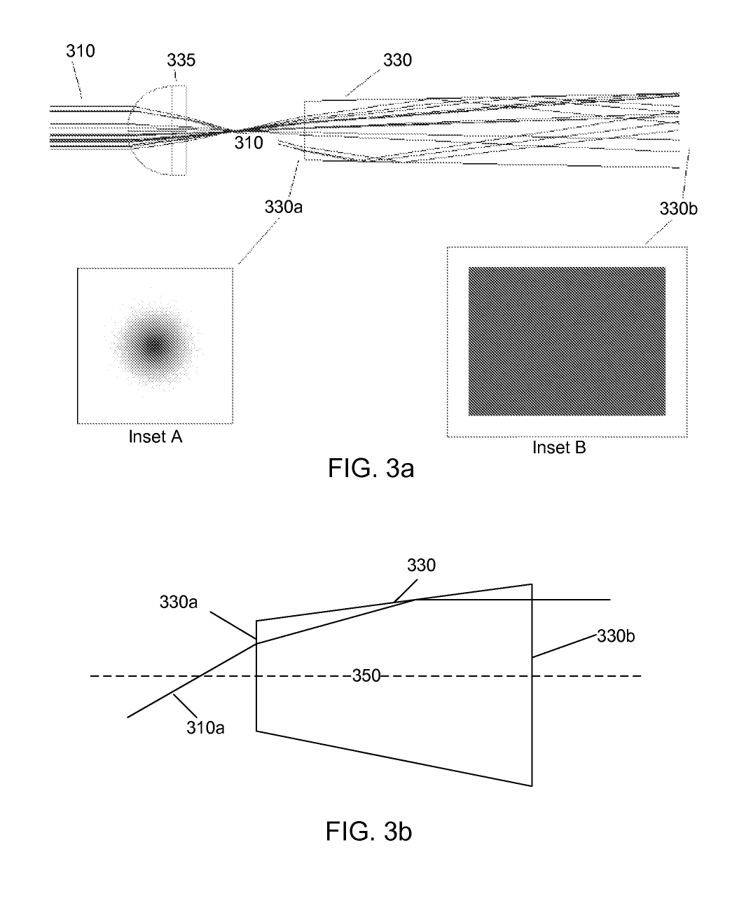

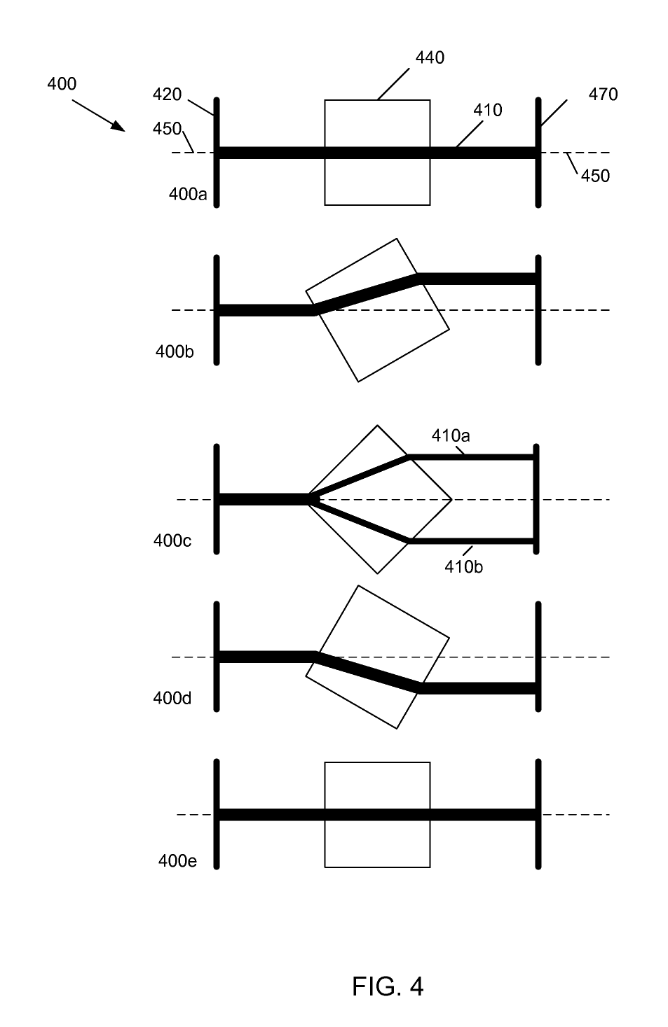

Referring now in detail to the drawing figures, wherein like reference numerals represent like parts throughout the several views, FIG. 2 illustrates an optical system 200 of a projection device according to an exemplary embodiment of the present invention. A light source 220 preferably emits a coherent light beam 210. In a preferred embodiment, the light source 220 is a laser and beam 210 is a laser beam. For illustration purposes, beam 210 is identified as beam segments 210a-g to highlight varying attributes of the beam as it propagates through the system. The beam segment 210a can propagate through air before reaching an integrating rod 230. The integrating rod 230 is employed in accordance with exemplary embodiments. In other contemplated embodiments, the integrating rod 230 may be omitted or replaced with a different optical component. For example, a fly-eye lens may be used in place of the integrating rod 230 or a laser beam with “top-hat” distribution could be employed negating the need for the integrating rod 230. The beam segment 210b preferably propagates through the integrating rod 230 and is homogenized as described in relation to FIGS. 3a-b below. Beam segment 210c preferably propagates through air upon exiting the integrating rod 230 prior to interacting with refractive element 240. The refractive element 240 may be continually rotated clockwise or counterclockwise by a rotation element 245, resulting in a varying refracted propagation path of beam segment 210d. The rotation of the refractive element 240 causes the beam segment 210e to scroll depending on the rotation of the refractive element as described in greater detail below in relation FIG. 4.

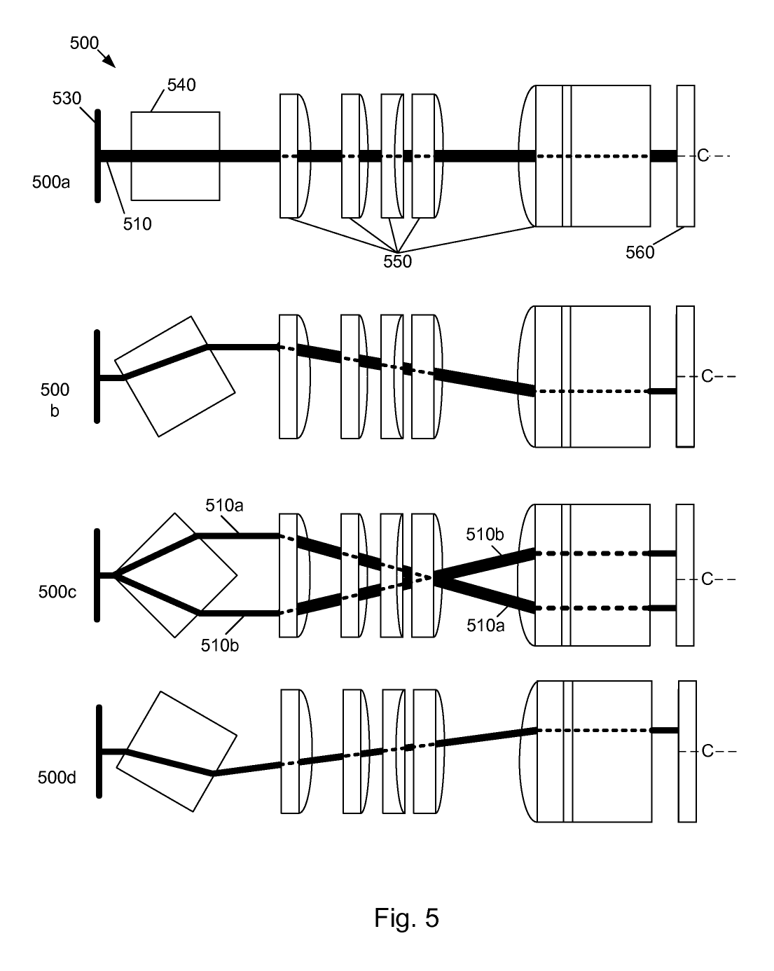

The beam segment 210f propagates through air and a plurality of optical components 250. The optical components focus and manipulate the beam 210 such that it forms a desired image as it passed through the light valve 260. The optical components 250 may effectively reverse the scrolling direction of the beam 210 created by the refractive element 240 as described below in relation to FIG. 5. The beam segment 210g interacts with and forms an image upon light receiving element 270. The image formed by beam segment 210g preferably scrolls along the surface of the light receiving element 270 depending upon the configuration of refractive element 240 and optical components 250.

FIG. 3a illustrates an integrating rod for homogenizing a light beam according to an exemplary embodiment of the present invention. A light beam 310 is preferably emitted from a coherent light source (not shown). The rays of the beam 310 are typically substantially parallel, closely approximating a Gaussian beam. The beam 310 is preferably focused by a lens 335 and enters the front of the integrating rod 330a. The integrating rod 330 is preferably glass or another suitable refractory material. In other contemplated embodiments, the integrating rod 330 may be a hollow tube filled with mirrors along its interior surface.

The rays of the light beam 310 enter the front of the integrating rod 330a and are refracted. As the beam 310 propagates through the rod 330, the rays reflect of the interior surface of the rod 330 until the beam 310 exits the rod 330 at the back of the integrating rod 330b. Inset A illustrates a cross section of the beam 310 before it enters the front of the integrating 330a. The intensity of the beam 310 is greatest at the center and diminishes along the radius extending from the center. Inset B illustrates the a cross section of the beam 310 as it exits the back of the integrating rod 330b. The intensity of the beam 310 is preferably homogenized and is approximately equal through out the cross section of the beam 310.

FIG. 3b illustrates an integrating rod 330 according to an embodiment of the present invention. The integrating rod 330 is preferably frustoconical in shape. The front of the integrating rod 330a preferably has a smaller cross section that the back of the integrating rod 330, resulting in the entrance of the rod 330 being tapered. The tapering of the integrating rod 330 preferably reduces the étendue of the beam 310. The étendue is determined by the size of the entrance and exit of the integrating rod and the opening angle of the light cone formed by the beam 310 leaving the integrating rod 330. The size of the back of the integrating rod 330b is preferably dependent on the size of the light valve 260. The front of the integrating rod 330a is preferably dependent upon the size of the back of the integrating rod 330b, and is preferably selected to minimize the increase in étendue caused by the integrating rod 330.

The tapering of the integrating rod 330 introduces changes in the angles of the rays of the light beam 310, as depicted by ray 310a, with respect to the axis of propagation 350. The refractive and reflective properties of the integrating rod 330 preferably result in a reduction in the angle of the cone of the light beam 310 which was introduced to cause homogenization. As a result, the étendue of the beam 310 after exiting the integrating rod 330b is preferably equal or at least not much bigger than the étendue of the beam before entering the integrating rod 330a.

Upon exiting the integrating rod 330, the beam 310 preferably interacts with a refractive element 240. FIG. 4 illustrates various phases of the rotation of a refractive element 440 according to an exemplary embodiment of the present invention. A light beam 410 preferably emanates from a coherent light source 420. The coherent light source 420 can be a laser light source. Prior to interacting with the refractive element 440, the beam 410 may be homogenized by an integrating rod 330 as described above in relation to FIG. 3a-b, however, the integrating rod is not illustrated in FIG. 4. The refractive element 440 is preferably a polygonal prism. The beam 410 may propagate through the refractive element 440 and be refracted depending upon the position of the refractive element 440 as it rotates. After the beam 410 exits the refractive element 440, the beam 410 interacts with a light receiving element 470, upon which the beam 410 forms and image. Prior to reaching the light receiving element 470, the beam 410 may interact with one or a plurality of optical components 250 and the light valve 260 described above in FIG. 2. For the purposes of illustrating the scrolling effect of the refractive element 440 only, the optical components 250, the light valve 260, and their effect on the beam 410 will not be discussed or illustrated.

At phase 400a the refractive element 440 is at an angle of zero (0) degrees to the initial propagation axis 450 of the beam 410, resulting in the sides of the refractive element being perpendicular to the beam and the angle of incidence being substantially zero (0) degrees. The beam 410 passes directly through the refractive element 440 and forms an image on the light receiving element 470 centered about the propagation axis 450.

At phase 400b, the refractive element 440 is preferably rotated substantially 30 degrees counterclockwise. As a result, the angle of incidence of the beam 410 is 30 degrees and the beam 410 is refracted above the propagation axis 450 according to Snell's Law. Upon exiting the refractive element 440, the angle of incidence at the side of the element 440 preferably causes the beam 410 to again be refracted, effectively reversing the refraction upon entering the refractive element 440, enabling the beam 410 to continue propagating parallel to the propagation axis 450, although the beam 410 is no longer centered about the axis 450. As a result, the beam 410 interacts with the light receiving element 470 to form and image above the intersection of the propagation axis 450 and the receiving element 470.

The change in angle of the refractive element 440 between phase 400a and 400b is preferably caused by a continuous rotation of the element 440, rather than being incremental. As a result the image produce by the beam 410 preferably gradually scrolls up the receiving element 470. This rotation is present between all of phases 400a-e. The counterclockwise rotation of the refractive element 440 is preferred, although the refractive element 440 may rotate clockwise in other contemplated embodiments, resulting in the image on the receiving element scrolling down. This correlation between rotation and scrolling may be present in this illustration only. For example, optical components 250 may reverse this correlation causing counterclockwise rotation to result in downward scrolling and clockwise rotation to result in upward scrolling. The correlation between rotation and scrolling may also be affected by other components and arrangements of the optical system 200.

At 400c, the refractive element 440 is preferably rotated substantially 45 degrees counterclockwise. The angle of incidence of the beam 410 is 45 degrees and the beam 410 is preferably spilt into two (2) separate streams, 410a and 410b, and refracted be two adjacent sides of the refractive element 440. Stream 410a, representing the lower half of beam 410, is refracted up with respect to the propagation axis 450 and steam 410b, representing the upper half of beam 410, is refracted down. Exiting the refractive element 440, the streams 410a and 410b are again refracted as the angle of incidence with the border of the refractive element 440 is not zero. The angle of refraction of the streams 410a and 410b exiting the refractive element 440 is preferably equal and opposite the angle of refraction of the streams 410a and 410b entering the refractive element 440. Accordingly, streams 410a, 410b again propagate parallel to the propagation axis 450, with stream 410a propagating above stream 410b. Stream 410a interacts with and forms an image on receiving element 470 substantially above the propagation axis 450, while stream 410b forms and image below the propagation axis 450. As a result, the bottom of the image appears at the top of the receiving element 470 and the top of the image appears at the bottom.

At phase 400d, the refractive element is rotated 60 degrees counterclockwise. This angle of incidence produces the reverse effects of the refractive element 440 at phase 400b. The light beam 410 is refracted down with respect to the propagation axis 450, and is again refracted upon exiting the refractive element 440 so that it propagates parallel to the propagation axis 450. The beam 410 forms an image on the receiving element 470 below the propagation axis 450, but above the image formed by stream 410b at phase 400c. At phase 400e, the refractive element is rotated 90 degrees and its effects are substantially identical to phase 400a. Consequently, the beam 410 forms an image on receiving element 470 centered about the propagation axis 450.

The gradual rotation of the refractive element through phases 400a-e produces a scrolling effect wherein the image formed by beam 410 moves up along the receiving element 470 and is redisplayed at the bottom of the receiving element 440 as it continues to scroll up. The rotation of refractive element 440 is preferably continuous resulting the image continually scrolling up the receiving element.

The refractive element 440 depicted in FIG. 4 is preferably a polygonal prism. In a preferred embodiment, the refractive element 440 is preferably a glass cube. The dimensions of the refractive element 440 are preferably related to the dimensions of the light beam 410 and a light valve of a light projection device. In other contemplated embodiments other materials such as plastic may be used to construct the prism. In other embodiments, the prism may be constructed from a plurality of subcomponents. In further contemplated embodiments, the refractive element may have a different even sided polygonal shape having parallel sides, such as a hexagon, octagon, decagon, etc. The contemplated shapes of the refractive element preferably maintain the scrolling effect, although the relation between the angle of the element and position of the image on the receiving element 440 will vary from those described in relation to FIG. 4 depending on the selected shape.

FIG. 5 illustrates a portion of the optical system 500 according to an exemplary embodiment of the present invention. The portion of the optical system 500 is depicted at varying phases 500a-d, corresponding to various phases of the rotation of the refractive element similar to the phases depicted in FIG. 4. In the portion of the optical system 500, a homogenized beam 510 is preferably emitted from the back of the integrating rod 530. The beam 510 propagates through refractive element 540, which refracts the beam 510 depending on the angle of rotation of the element 540. Upon exiting the refractive element 540, the beam 510 propagates through a plurality of optical components 550, which focus and manipulate the beam 510 so that it preferably forms an image on a light valve 560.

At phase 500a, the refractive element is rotated zero (0) degrees as described above in relation to phase 400a in FIG. 4. The beam 410 propagates substantially straight through the refractive element 540 and optical components 550 and forms an image on the light valve 560 centered about the center central line C of the light valve 560. The width of the beam 510 is preferably smaller than the surface of the light valve 560, although the drawing is not to scale. As a result, at a particular instant, only a predetermined portion of the surface of the light valve 560 is illuminated by the beam 510.

At phase 500b, the refractive element is rotated 30 degrees as described above in relation to phase 400b in FIG. 4. The beam 410 is refracted upward relative to its propagation axis. Upon exiting the refractive element 540, the beam 410 interacts with the optical components 550 at a position off-center compared with its interaction at phase 500a. As a result the angle of incidence of the beam 510 to the lenses and surfaces of the optical components 550 is varied from that of phase 500a. The optical components 550 preferably refract the beam 510 downward, resulting in the beam 510 illuminating a portion of the light valve 560 below the center line C.

At phase 500c, the refractive element 540 is rotated 45 degrees as described above in relation to phase 400c in FIG. 4. The beam 510 is preferably split into a first stream 510a, presenting the bottom portion of the beam 510, and a second stream 510b, representing the top portion of the beam 510. The first stream 510a is preferably above the second stream 510b. The lenses and refractive properties of the optical components 550 preferably refract the streams such that the second stream 510b illuminates a portion of the light valve 560 above the center line C and the first stream 510a illuminates a portion of the light valve below the center line C.

At phase 500d, the refractive element 540 is rotated 60 degrees as described above in relation to phase 400d in FIG. 4. The beam 510 is preferably refracted by the optical components 550 such that is illuminates a portion of the light valve above the center line C. As the refractive element is rotated to 90 degrees, the beam 510 again illuminates a portion of the light valve at the center line C. The refractive element 540 preferably continually and gradually rotates as described above in relation to FIG. 4.

The rotation of the refractive element 540 causes the beam 510 to scroll across the surface of the light valve 560. The beam 510 may scroll up or down across the light valve 560 depending on the rotation of the refractive element 540 and arrangement of the optical components 550. As the beam reaches the border of the light valve, it preferably also reaches a corner of the refractive element 540, causing a portion of the beam 510 to jump from illuminating the bottom of the light valve 560 to illumination the top, if the beam 510 is scrolling down.

The refractive element 540 is preferably positioned close to the light source, for example directly behind the back of the integrating rod 530b, i.e. close to a so-called image plane. If the refractive element 540 is in the horizontal position, the light beam 510 passes through the refractive element 540 and optical components 550, arriving at the light receiving element in the same relative orientation as it was emitted. Rotation of the refractive element 540 near the image plane causes the image to scroll across the light receiving element 570, but does not change the propagation axis of the light beam 530 prior passing through the optical components 540. The optical components 550 are particularly arranged to adjust and focus the light beam 510 onto the light receiving element 570 based upon the propagation axis of the light beam 510 as it is emitted from the light source 520. If the refractive element 540 where placed in the aperture plane within the optical components 550, the propagation axis of the light beam would constantly change as the refractive element 540 rotates, however, the optical components 550 would remain static and unable to compensate for the rotation to refocus the light beam 510 on the light receiving element 570. Consequently, the image would be disjointed and unfocused when arriving at the light receiving element and would not smoothly scroll across the light receiving element 570. Therefore, the refractive element 540 is preferably not disposed near the aperture plane between the various optical components 550. Disposing the refractive element 540 between the elements of the optical components 550 would prevent the scrolling effect produced by the rotation of the refractive element 540 from being achieved.

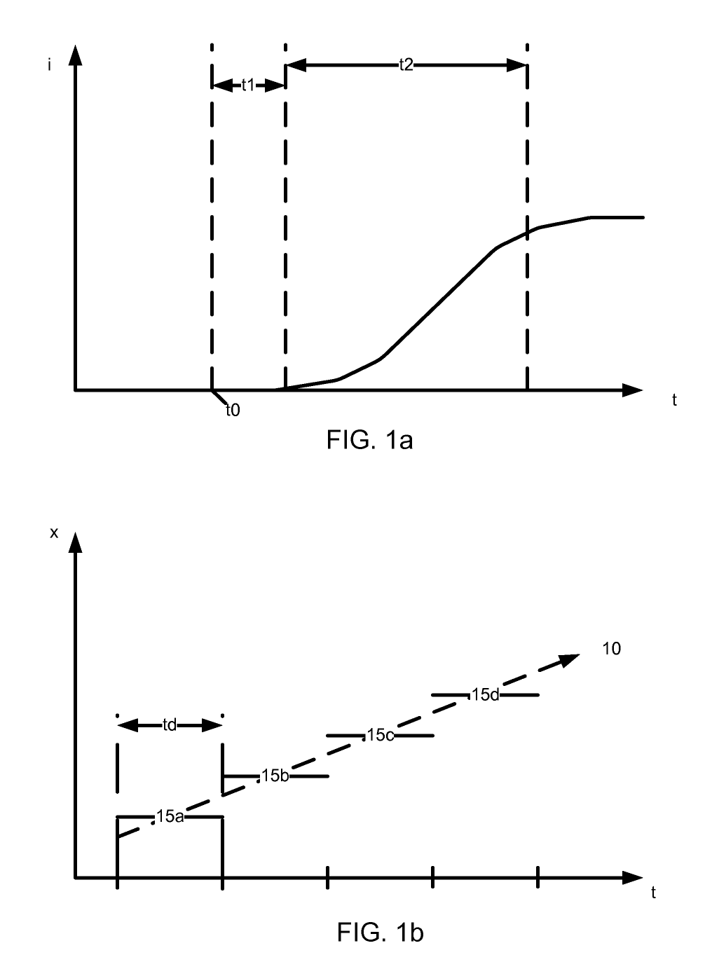

In a preferred embodiment, the refractive element 540 causes the beam 510 to scroll up along the surface of the light valve 560. The light valve 560 preferably comprises a plurality of rows of pixels. The pixels of the light valve 560 are addressed starting with the bottom row in accordance with a particular refresh rate of the light valve 560. The scrolling of the beam 510 is preferably synchronized with the addressing of the pixel rows such that there is a delay between a row being addressed and the row being illuminated by the beam 510. This delay is preferably substantially equal in time to the delay in response time of a pixel described in FIGS. 1a-b. As the rows are addressed from the bottom of the light valve 560 up, the beam 510 scrolls up the light valve preferably illuminating the pixels after the pixels have had a sufficient time to recognize the voltage and the crystals have appropriately rotated. In this manner the scrolling of the beam substantially reduces the smearing phenomenon caused by the delay in response time of the pixel as only ready pixels are illuminated. In other contemplated embodiments, the rows can be addressed from the top of the light valve 560 down.

Reduction of the speckle phenomenon can be explained by the wave nature of light and the ability of refractive elements to induce a phase shift in adjacent light rays. A light ray can be represented as an electromagnetic wave with an electrical field component E and a magnetic field component B. From the wave equation a sinusoidal solution is found, E=E₀ sin(ωt−kx), with an angular frequency ω=2πf=2π c/nλ and a wave number k=2π/λ. The speed of light is designated by c and the refractive index of the material the wave is propagating through is designated by n. The wavelength of the electromagnetic ray is designated by λ. It can be derived that λ=λ₀/n where λ₀ is the wavelength of a light ray in a vacuum, which closely approximates the wavelength of light in air.

In crown glass, such as BK7, the refractive index n is equal to 1.52, reducing the wavelength λ of light by one third (⅓). As a result, the peaks of the wave are closer together and light travels slower through the material.

Attributes of the various exemplary embodiments of the present invention induce a phase shift in the rays of the beam emanating from the light source. The refractive element and optical components have a refractive index higher than air, resulting in the propagation speed of the rays decreasing as they pass through these materials. The rotation of the refractive element constantly varies the propagation path of the rays. As a result, the distance the rays travel through the optical components and refractive element is constantly changing. The changing propagation path and distance traveled through the optical components and refractive element and optical components results in a phase shift in the rays of the beam passing through a certain location on the light valve and projected onto a light receiving element. The changing phase shift in the rays creates a variable interference pattern on the light receiving element, resulting in a reduction in the appearance of the speckle phenomenon. The principle behind phase shift induced in light rays traveling a different distance through a refractive material is described in greater detail below.

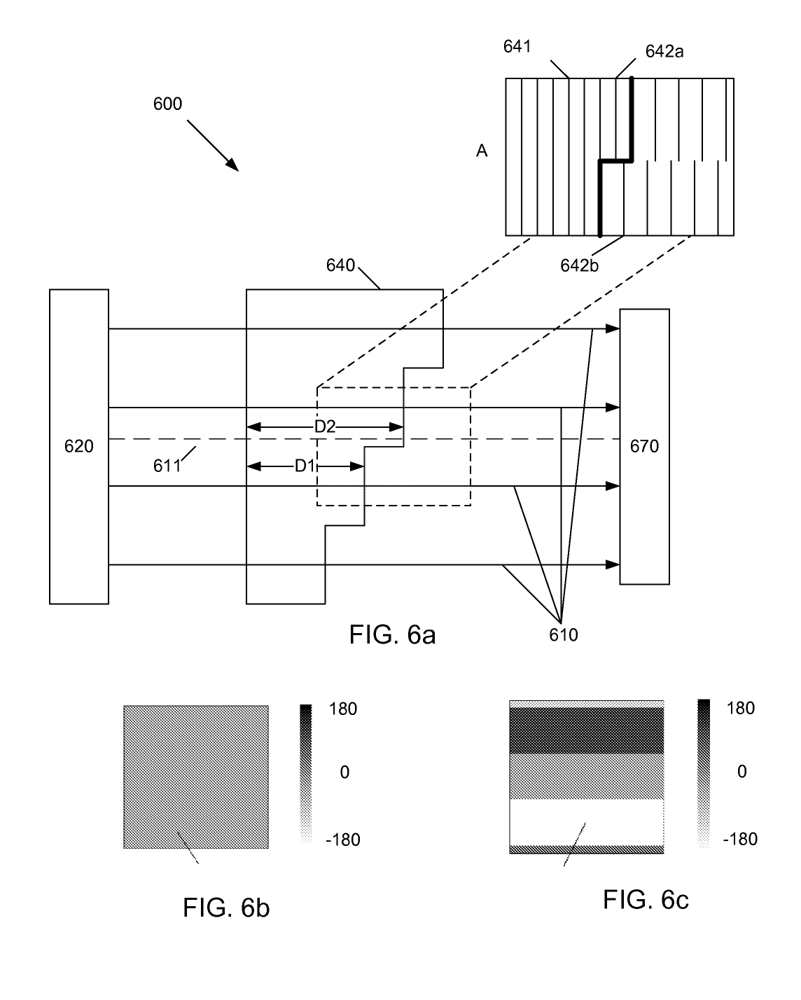

FIG. 6a illustrates the principle of phase shift in a coherent light beam as the beam propagates through a refractive element. The components and description of FIG. 6a are solely for the purposes of illustrating the ability of refractive elements to induce phase shift in a light beam and do not constitute actual embodiments of the present invention. A plurality of parallel light rays 610 preferably emanate from a common light source 620. An exemplary light source may be a laser light source. The rays 610 preferably travel through air prior to reaching an exemplary refractive element 640. The rays 610 preferably propagate parallel to a propagation axis 611. The refractive element 640 may be composed of a refractive material such as glass, plastic, or another material with a suitable index of refraction n. The refractive element 640 is preferably transparent or translucent, having a minimal opacity, to the frequency of light being used. For simplicity, the angle of incidence of the light rays 610 is preferably zero (0) degrees.

The refractive element 640 has a stair-like shape such that its width varies incrementally along one of its sides. The refractive element 640 preferably has at least a first width of distance d₁ and a second width of distance d₂, wherein d₁ is less than d₂. Consequently, as light rays 610 pass through the refractive element 640, certain rays will travel a distance d₁ whereas others will travel a distance d₂. After passing through the refractive element 640, the rays 610 preferably travel through air parallel to propagation axis 611 before reaching a light receiving element 670. The rays 610 preferably display a pattern or image on the light receiving element 670.

In general, wave fronts of rays of a coherent light source, such as light source 620, propagate in unison. The wave fronts leaving the light source 620 together and arrive at the light receiving element 670 at the same time. This occurs because the wave fronts travel the same distance at the same speed. Placing the refractive element 640 between the light source 620 and light receiving element 670 does not change the total distance the rays 610 travel, but does change the distance the rays travel through the refractive element 640. Since the refractive element 640 has an index of refraction greater than air, the rays 610 will travel slower through the refractive element 640 than through air. Consequently, wave fronts that travel a greater distance through the refractive material will reach the light receiving element 670 after wave fronts that travel a shorter distance. The result is that the waves fronts traveling different distances through refractive material will no longer be in phase.

Inset A illustrates the phase shift of rays 610 traveling through the refractive element 640 as the rays exit the refractive element 640. The line 641 represents the wave fronts of adjacent rays 610 propagating together, in phase, and at the same speed through the refractive element 640. Lines 642a and 642b represent the wave fronts of rays that were previously in phase. The wave fronts at 642b have exited the refractive element 640 and travel at a greater speed than the wave fronts at 642a, which remain in the refractive element 640. As a result, wave fronts at 642b have traveled a greater distance than wave fronts at 642a in the same amount of time, and are no longer propagating in phase. In this manner, the refractive element 640 causes a phase shift in the rays 610 that propagate through it.

FIGS. 6b and c illustrate measurements from two phase detectors. FIG. 6b illustrates measurements from a phase detector located between the light source 620 and the refractive element 640. The rays 610 propagate in unison and no phase differences are detectable. FIG. 6c illustrates measurements from a phase detector located between the refractive element 640 and the light receiving element 670. Clear bands are evident demonstrating the rays traveling different distance though the refractive element 640 pass through the phase detector at different phases.

Referring back to the embodiments described above, it is evident that at time t0, the light rays arriving at the light receiving element will have gone through a certain physical part of the optical components of the system, generating a certain interference pattern on the screen, with a certain speckle pattern at pixel position p0. However, at time t0+Δt, the refractive element has rotated slightly, which causes the light path to change. The light ray hitting a pixel p0, is emerging from another point at the image plane which may corresponds to the exit of the integrating rod, and the light has traveled through other physical parts of the optical components, causing another interference pattern on the screen. As these interference patterns vary in time, the overall speckle contrast will be dramatically reduced.

Referring in particular to FIG. 2, it is clear that refractive element 240 will not eliminate speckle phenomena in a projection device. One particular orientation of the refractive element will lead to a certain phase relation between the rays reaching the light receiving element 270. This will result in a static speckle pattern different from the pattern observed without the element. Completely eliminating various interference patterns on the light receiving element 270 is impossible because of the wave nature of light, refractive properties of air, and focusing necessary in a projection device. The only practical solution is to homogenize the effect by constantly vary the speckle pattern by means of changing the orientation of the refractive element 240 so that it is not static, thereby reducing its visibility. An optical system with static components will always produce a static speckle pattern.

The embodiments of the invention described above reduce the speckle pattern since the path of the rays of the beam through the refractive element and optical components is constantly varied. As the refractive element rotates the rays are continually being retracted and their paths altered. The rays pass through different portions of the optical components, following different paths. Consequently, certain rays travel a greater or lesser distance that other rays, resulting in varying relative phase shift. This phase shift of the rays is continually changing as the refractive element rotates. As a result, the interference pattern on the light receiving element changes as well. Because the interference pattern varies with the rotation of the refractive element and is not static, the various patterns are blended together by the human eye and are homogenized. Thus, the speckle pattern is less observable.

While the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all applicable equivalents.

1. An optical system for reducing image artifacts in a light projection system, the optical system comprising:
a light valve having a plurality of rows of pixels;
a monochromatic coherent light source emanating a light beam illuminating the pixels of the light valve;
a plurality of optical components directing the light beam onto the light valve; and
a rotating refractive element refracting the light beam emanating from the monochromatic coherent light source, the refractive element having a geometric configuration and isotropic refractive properties such that the propagation axis of a light ray exiting the refractive element is approximately parallel to the propagation axis of the ray entering the refractive element, the rotation of the refractive element altering the propagation path of the light beam through the optical components, wherein the optical components cause two or more rays refracted by the refractive element to undergo relative phase shift, the axis of rotation of the refractive element approximately perpendicular to the propagation axis of the light beam.

2. The optical system of claim 1, further comprising an integrating rod homogenizing the light beam, the integrating rod disposed between the monochromatic coherent light source and rotating refractive element.

3. The optical system of claim 1, the rotation of the refractive element synchronized with the refresh rate of the light valve.

4. The optical system of claim 1, the rotation of the refractive element being continuous.

5. The optical system of claim 1, wherein the refractive element is a polygonal prism.

6. The optical system of claim 1, wherein the monochromatic coherent light source is a laser.

7. The optical system of claim 1, the refractive element refracting the light beam such that the portion of the light valve illuminated by the beam is dependent upon the rotation of the refractive element.

8. The optical system of claim 1, the rotation of the refractive element synchronized with the refresh rate of the light valve such that a row of pixels is illuminated by the beam a predetermined time after the row of pixels has been addressed.

9. A rotational refractive device for reducing image artifacts in a light projection system, the rotational refractive device comprising:
a refractive element refracting a light beam emanating from a monochromatic coherent light source, the refractive element having a geometric configuration and refractive properties such that the propagation axis of a light ray exiting the refractive element is approximately parallel to the propagation axis of the ray entering the refractive element; and
a rotation element rotating the refractive element about a rotational axis substantially perpendicular to the propagation axis of the light beam, the rotation of the refractive element altering the propagation path of the light beam causing two or more rays refracted by the refractive element to undergo relative phase shift.

10. The refractive device of claim 9, the rotation of the refractive element synchronized with the refresh rate of a light valve.

11. The refractive device of claim 9, wherein the refractive element is a polygonal prism.

12. The refractive device of claim 9, wherein the refractive element is adapted to receive a homogenized light beam from an integrating rod.

13. The refractive device of claim 9, the refractive element refracting the beam such that the portion of the light valve illuminated by the beam is dependent upon the rotation of the refractive element.

14. The refractive device of claim 10, wherein the light valve has a plurality of rows of pixels, and the rotation of the refractive element is synchronized with the refresh rate of the light valve such that a row of pixels is illuminated by the beam a predetermined time after the row of pixels has been addressed.

15. A method for reducing image artifacts in a light projection system, the method comprising:
emanating a monochromatic coherent light beam;
refracting the light beam using a refractive element;
rotating the refractive element about a rotational axis substantially perpendicular to the propagation axis of the light beam;
projecting the refracted light beam through a plurality of optical components to induce a relative phase shift in the rays of the light beam and projecting the refracted beam by way of a light valve onto a light receiving element; and
synchronizing the rotation of the refractive element with the refresh rate of the light valve.

16. The method of claim 15, further comprising homogenizing the beam of light.

17. The method of claim 15, emanating a beam of light comprising emanating a beam of light from a laser.

18. The method of claim 15, refracting the light beam such that the propagation axis of a light ray exiting the refractive element is approximately parallel to the propagation axis of the ray entering the refractive element.

19. The method of claim 15, synchronizing the rotation of the light beam comprising synchronizing the rotation of the refractive element with the refresh rate of the light valve such that a row of pixels is illuminated by the beam a predetermined time after the row of pixels has been addressed.

20. The method of claim 15, wherein the relative phase shift is caused by altering the propagation path of the light beam through the plurality of optical components by rotating the refractive element.
